(19) United States
(12) Patent Application Publication
(10) Pub. No.: US 2008/0219017 A1
(43) Pub. Date: Sep. 11, 2008

(54) Multi-Color to White Light-Emitting Diode for Map Pocket Light

(75) Inventor: William Cruickshank, Rochester Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/682,597

(22) Filed: Mar. 6, 2007

(51) Int. Cl. B60Q 1/00

(52) U.S. Cl. 362/488

(57) ABSTRACT

An automobile interior component having color adjustable illumination has a plurality of light-emitting diodes of varying color spectra, a controller that adjusts the color spectrum of the diodes, and a control switch to set the emitted light to a first predetermined color. An activation switch functions as an on/off switch and/or as a switch that transitions the emitted light from the first predetermined color to a second predetermined color and back again if desired.

### BACKGROUND OF THE INVENTION

1. Field of the Invention

In at least one aspect, the present invention relates to color adjustable vehicle interior lighting.

2. Background Art

Competitive pressure places a persistent demand on automobile manufacturers and suppliers to improve aesthetics and functionality of vehicle components. Numerous vehicle interior components include illumination sources to enhance visibility or to provide a pleasing environment. Instrument panels, the vehicle cabin, glove compartment, and other storage component typically include lighting to improve visibility. Door panels sometimes include lightening to provide an aesthetically pleasing mood. This latter variation is usually referred to as mood lighting.

Prior art light schemes in automobile interiors utilize incandescent lighting, electroluminescent lighting, and the like. Although these lighting elements work reasonably well, each requires relatively frequent replacement which is at best inconvenient. Moreover, the relatively short life of these prior art lighting elements limits the complexity of lightening applications that are useful in automotive interiors.

Accordingly, there exists a need for improved lighting systems to be included in automobile interiors.

### SUMMARY OF THE INVENTION

The present invention solves one or more problems of the prior art by providing in at least one embodiment, an illuminated automobile interior component. The illuminated automobile interior component is able to provide mood lighting, light for either illumination, or both, depending on the desire of the automobile manufacturer. An automobile interior component design to provide both mood light and light for illumination may optionally be set by a user. The automobile interior component of the present embodiment includes an LED assembly attached to a plurality of light-emitting diodes. Each light-emitting diode of the plurality of light-emitting diodes emits light with a characteristic visible light spectrum. The light emitted from each light-emitting diode of the plurality of light-emitting diodes is combined together to produce a combined light characterized by a first predetermined color. In order to set the intensity of light emitted from each diode, a controller assembly that adjusts the light emitted from each light-emitting diode is in communication with the plurality of light-emitting diodes. Inclusion of an optional activation switch allows either activation or deactivation of the plurality of light emitting diodes or transition from the first predetermined color to a second predetermined color.

### BRIEF DESCRIPTION OF THE DRAWINGS

FIG. 1 is a perspective view of a vehicle door integrating an embodiment of an automobile interior component with an integrated LED assembly;

FIG. 2 is a schematic diagram of the integration of the LED assembly into the interior component shown in FIG. 1; and

FIG. 3 is a diagram illustrating the control of the LED assembly of FIGS. 1 and 2.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

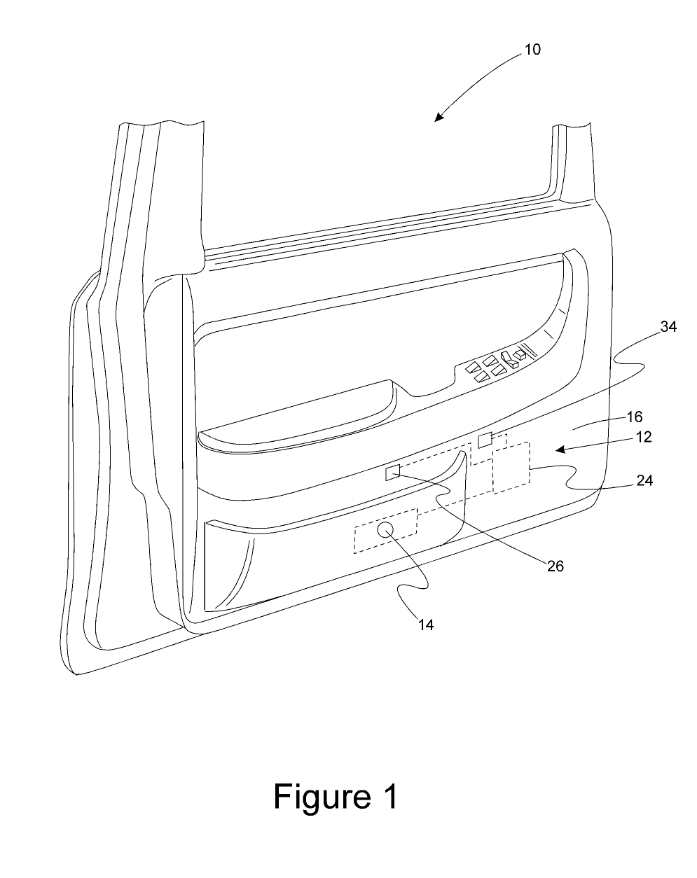

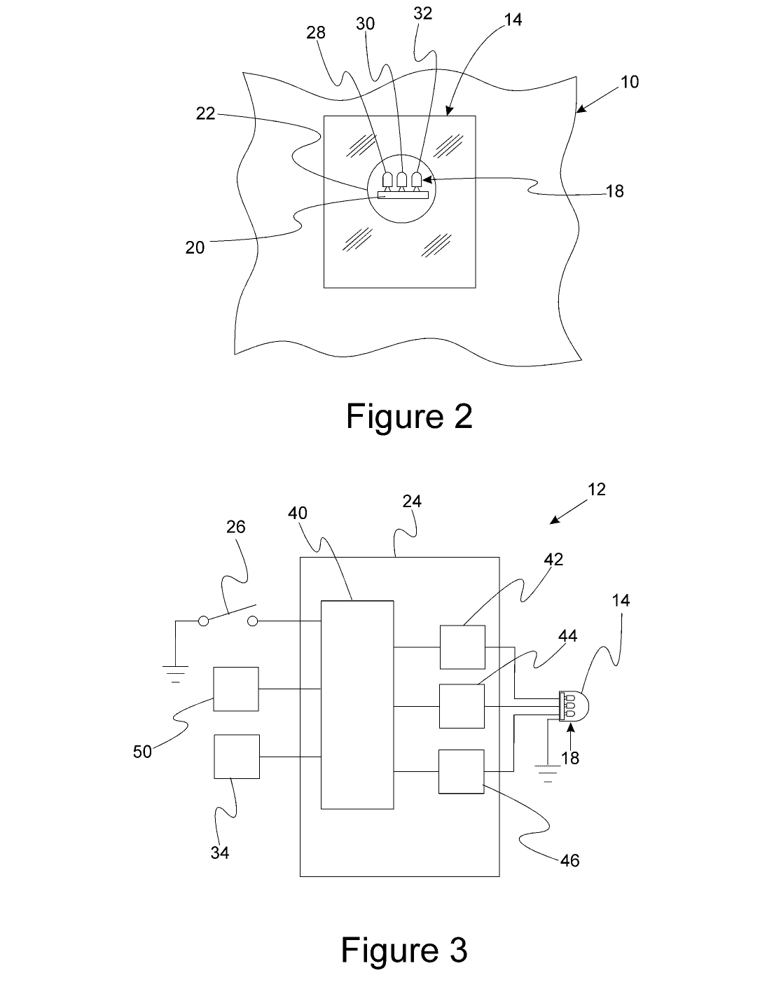

With reference to FIGS. 1 and 2, schematic illustrations of an automobile interior component having a lighting assembly are provided. FIG. 1 is a perspective view of a vehicle door integrating an embodiment of an automobile interior component with integrated light-emitting diode (“LED”) assembly. FIG. 2 is a schematic diagram of the integration of the LED assembly into the interior component. Automobile interior component 10 includes LED lighting system 12. In the example depicted in FIGS. 1 and 2, automobile interior component 10 is part of a door. Lighting system 12 includes LED assembly 14 attached to panel 16. Plurality of light-emitting diodes 18 are optionally attached to diode receptacle 20. Examples of useful LEDs include, but are not limited to, the MULTILED™ commercially available from OSRAM Opto Semiconductors GmbH. Plurality of light-emitting diodes 18 may be individually housed or assembled into a single diode housing 22. Each light-emitting diode of the plurality of light-emitting diodes 18 emits light with a characteristic visible light spectrum. Moreover, light emitted from each light-emitting diode of the plurality of light-emitting diodes 18 is combined together to produce a combined light characterized by a first predetermined color. In order to set the intensity of light emitted from each diode, LED lighting system 12 also includes controller assembly 24 in communication with the plurality of light-emitting diodes 18. Controller assembly 24 adjusts the light emitted from each light-emitting diode so that light characterized by the first predetermined color is provided.

In a variation of the present embodiment, LED lighting system 12 includes control switch 26 which is in communication with controller assembly 24. Control switch 26 allows a vehicle occupant to input information regarding a desired color to be outputted from the plurality of light-emitting diodes 18.

In a variation of the present embodiment, plurality of light-emitting diode 18 comprises 3 light-emitting diodes. Typically, a diodes emitting each of the primary colors or an approximation thereto will be utilized. For example, in this variation, plurality of light-emitting diode 18 may include blue light-emitting diode 28, red light-emitting diode 30, and a green light-emitting diode 32.

In another variation of the present invention, LED lighting system 12 includes activation switch 34. Activation switch 34 is operable to either activate or deactivate the plurality of light emitting diodes (i.e., operate as an on/off switch) or to transition the emitted light from the first predetermined color to a second predetermined color. In a particularly useful variation of the present embodiment, activation switch 34 comprises a proximity sensor. Examples of proximity sensors include, but are not limited to, infrared proximity sensors and capacitive proximity sensors. In a refinement of this latter variation, light emitted from the plurality of light-emitting diodes switches from the first predetermined color to the second predetermined color when an object is with a predetermined distance of the proximity sensor. In one refinement the first predetermined color is for mood effect. In another refinement, the second predetermined color is provided for better visibility (e.g., white light) than the first predetermined color. When the second predefined color is white, the second predetermined color is formed by a combination of light from several light-emitting diodes or from a white light emitting diode.

LED lighting system 12 may be integrated into any automobile interior component in which lighting is desired. In one particularly useful, plurality of light-emitting diodes 16 are integrated into a vehicle interior door panel in order to provided mood lighting and/or lightening to enhance visibility. In a further refinement to such an application, plurality of light-emitting diodes 16 are positioned proximate to a map pocket to allow enhanced visibility when an occupant seek access to such a map pocket.

With reference to FIG. 3, a diagram illustrating the control of LED assembly 14 is provided. Control assembly 24 includes controller 40. In one variation, controller 40 is a programmable controller. Examples of useful controllers assemblies include, but are not limited to, the PSoC™ family of mixed signal arrays commercially available from Cypress Semiconductor Corp. This family of controllers are mixed signal arrays with on-chip controller devices. These controllers include flash memory, SRAM data memory, CPU, and a configurable input/output (“I/O”). Control assembly 24 also includes electronic drivers 42, 44, 46 associated with each light-emitting diode of the plurality of light-emitting diodes 16. Examples of useful electronic drivers include, but are not limited to, the high current LED drivers such as NUD4001 commercially available from On Semiconductor. Electronic drivers 42, 44, 46 are in communication with controller 40. Typically, electronic drivers 42, 44, 46 are in electronic communication with controller 40. Electronic drivers 42, 44, 46 may used any method now in the art for adjusting the light output. Examples of such methods include, but are not limited to, pulse width modulation, voltage control, and currently control. Electronic drivers 42, 44, 46 receives a control signal from the controller in response to which the light output from each light-emitting diode is adjusted. Electronic drivers 42, 44, 46 may used any method now in the art for adjusting the light output. Examples of such methods include, but are not limited to, pulse width modulation, voltage control, and currently control. Control switch 26 is in communication (typically electronic communication) with control assembly 24. As set forth above, control switch allows a user to input information regarding a desired color to be outputted from to the plurality of light-emitting diodes 18. This allows the user to set the colors of first predetermined color. In another refinement, the user is also able to use either control switch 26 or an additional control switch to set the color of the second predetermined color. Activation switch 34 is also in communication with control switch 26. Also as set forth above, activation switch 34 is operable to either activate or deactivate the plurality of light emitting diodes or to transition the emitted light from the first predetermined color to a second predetermined color. Advantageously, activation switch 34 comprises a proximity sensor such that the light emitted from the plurality of light-emitting diodes 16 transitions from the first predetermined color to the second predetermined color when an object is with a predetermined distance of the sensor. Examples of proximity sensors include, but are not limited to, infrared proximity sensors and capacitive proximity sensors. In one refinement the first predetermined color is for mood effect. In another refinement, the second predetermined color is provided for better visibility (e.g., white light) than the first predetermined color. When the second predefined color is white, the second predetermined color is formed by a combination of light from several light-emitting diodes or from a white light emitting diode. In this color transitioning variation, optional on/off switch 50 may be included to allow a user to completely disable the lighting system

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An automobile interior component having integrated lighting, the automobile interior component comprising:
an LED assembly, the LED assembly having a plurality of light-emitting diodes, each light-emitting diode of the plurality of light-emitting diodes emitting light with a characteristic visible light spectrum, wherein light emitted from each light-emitting diode of the plurality of light-emitting diodes is combined together to produce light characterized by a first predetermined color;
a controller assembly in communication with the plurality of light-emitting diodes, the controller assembly adjusting the light emitted from each light-emitting diode to the first predetermined color; and
a control switch in communication with the controller assembly, the control switch allowing a vehicle occupant to set the first predetermined color.

2. The automobile interior component of claim 1 further comprising an activation switch, the activation switch operable to either activate or deactivate the plurality of light emitting diodes or to transition the emitted light from the first predetermined color to a second predetermined color.

3. The automobile interior component of claim 2 wherein the activation switch comprises a proximity sensor.

4. The automobile interior component of claim 2 wherein the second predetermined color is substantially white, the second predetermined color being formed by a combination of light from several light-emitting diodes or from a white light emitting diode.

5. The automobile interior component of claim 4 wherein the light emitted from the plurality of light-emitting diodes switches from the first predetermined color to the second predetermined color when an object is with a predetermined distance of the proximity sensor.

6. The automobile interior component of claim 1 wherein the plurality of light-emitting diodes comprises 3 light-emitting diodes.

7. The automobile interior component of claim 1 wherein the plurality of light-emitting diodes comprises a blue light-emitting diode, a red light-emitting diode, and a green light-emitting diode.

8. The automobile interior component of claim 1 wherein the plurality of light-emitting diodes are integrated into a vehicle interior door panel.

9. The automobile interior component of claim 8 wherein the plurality of light-emitting diodes are positioned proximate to a map pocket.

10. The automobile interior component of claim 1 wherein the controller assembly comprises a programmable controller.

11. The automobile interior component of claim 1 wherein a light transmitting element position over the plurality of diodes.

12. The automobile interior component of claim 11 wherein the controller assembly further comprises an electronic driver for each light-emitting diode of the plurality of light-emitting diodes.

13. An automobile interior component having integrated lighting, the automobile interior component comprising:
an LED assembly, the LED assembly comprising a blue light-emitting diode, a red light-emitting diode, and a green light-emitting diode;
an LED driver assembly, the LED driver assembly comprising a blue light-emitting diode driver that provides current to the blue light-emitting diode, a red light-emitting diode driver that provides current to the red light-emitting diode, and a green light-emitting diode driver that provides current to the green light-emitting diode, wherein light emitted from each light-emitting diode is combined together to produce light characterized by a first predetermined color;
a programmable controller in communication with the LED driver assembly, the programmable controller able to adjust each driver of the LED driver assembly;
a control switch in communication with programmable controller, the control switch allowing a vehicle occupant to set the first predetermined color; and
an activation switch, the activation switch operable to either activate or deactivate the LED assembly or to switch the emitted light from the first predetermined color to a second predetermined color.

14. The automobile interior component of claim 13 wherein the activation switch comprises a proximity sensor.

15. The automobile interior component of claim 14 wherein the light emitted from the LED assembly transitions from the first color to the second color when an object is with a predetermined distance of the proximity sensor.

16. The automobile interior component of claim 14 wherein the proximity sensor is an infrared proximity sensor.

17. The automobile interior component of claim 13 wherein the LED assembly is integrated into a vehicle interior door panel.

18. The automobile interior component of claim 17 wherein the LED assembly is positioned proximate to a map pocket.

19. An automobile interior component having integrated lighting, the automobile interior component comprising:
an LED assembly, the LED assembly comprising a plurality of light-emitting diodes, each light-emitting diode of the plurality of light-emitting diodes emitting light with a characteristic, visible light spectrum, wherein light emitted from each light-emitting diode of the plurality of light-emitting diodes is combined together to produce light characterized by a first predetermined color; and
a proximity sensor, the proximity operable to transition light emitted from the LED assembly from the first color to a second color when an object is with a predetermined distance of the proximity sensor.

20. The automobile interior component of claim 19 further comprising a controller assembly in communication with the plurality of light-emitting diodes, the controller assembly adjusting the light emitted from each light-emitting diode to the first predetermined color.
